(19) United States
(12) Patent Application Publication
(10) Pub. No.: US 2009/0109209 A1
(43) Pub. Date: Apr. 30, 2009

(54) LIQUID CRYSTAL DISPLAY DRIVER AND LIQUID CRYSTAL DISPLAY DEVICE EQUIPPED WITH THE SAME

(75) Inventors: Kiyoshi Hidaka, Kanagawa-ken (JP); Hideyuki Sugawara, Kanagawa-ken (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 12/255,388

(22) Filed: Oct. 21, 2008

(30) Foreign Application Priority Data
Oct. 24, 2007 (JP) 2007-276707

(51) Int. Cl. G06F 3/038; G09G 5/10; G09G 3/36

(52) U.S. Cl. 345/214; 345/690; 345/87

(57) ABSTRACT

Image data is displayed on a screen of a liquid crystal panel on the basis of an interlaced image data, by a liquid crystal display driver. On the screen, identical images for two successive lines are displayed. The crystal display driver is provided with source line driving circuits for driving source lines of the liquid crystal panel. Each of the source line driving circuits includes an image data holding circuit, a mask data holding circuit to hold mask data containing replacement data for selectively replacing the image data. An image data masking circuit provides the replacement data and the image data read out from the image data holding circuit selectively. By the operation, a driving signal is provided to corresponding one of the source lines.

### CROSS REFERENCE TO RELATED APPLICATION

This application is based upon and claims the benefit of priority from the prior Japanese Patent Application No. 2007-276707, filed on Oct. 24, 2007, the entire contents of which are incorporated herein by reference.

### FIELD OF THE INVENTION

The present invention relates to a liquid crystal display driver and to a liquid crystal display device equipped with the same.

### DESCRIPTION OF THE BACKGROUND

A liquid crystal display driver is disclosed in Japanese Patent Application Publication (Kokai) No. 5-173503, for example.

In the publication, a data driver for displaying interlaced image data on a liquid crystal display is disclosed. When the interlaced image data is displayed on a liquid crystal display device, every half of data, i.e. every data for even- or odd-numbered lines of a whole frame is transferred to the liquid crystal display driver from the outside.

The data driver is provided with a latch. The latch holds data for one line transferred first. The held data for the one line is read out two times from the latch. The read-out data for the one line is continuously displayed in two lines. Displaying the same data in two lines is repeated in this manner.

As for displaying such interlaced image data on a liquid crystal display device, it is required that a graphic of a frame, for example, which consists of a line having a one-line width, should be displayed to overlaps a displayed image.

However, when interlaced image is displayed as described above, a graphic consisting of a line having a one-line width is not capable of being displayed on the displayed interlaced image. This is because the same data is continuously displayed in every two lines.

### SUMMARY OF THE INVENTION

An aspect of the invention provides a liquid crystal display driver which is provided with source line driving circuits for driving source lines of a liquid crystal panel so as to display identical images for two successive lines on a screen of the liquid crystal panel on the basis of an interlaced image data, wherein each of the source line driving circuits includes an image data holding circuit to hold interlaced image data, a mask data holding circuit to hold mask data to provide replacement data for selectively replacing the image data, and an image data masking circuit to provide the replacement data and the image data read out from the image data holding circuit selectively, in accordance with data obtained from the mask data holding circuit, so as to generate a driving signal to provide to corresponding one of the source lines.

Another aspect of the invention provides a liquid crystal display device which comprises a liquid crystal panel, a source driver including source line driving circuits to receive interlaced image data to drive source lines of the liquid crystal panel, a gate driver to drive gate lines of the liquid crystal panel, a mask data generation unit to providing the source driver with mask data for providing replacement data of the image data, and a control unit to control the source driver and the gate driver, wherein the image data is provided to the source line driving circuits so as to display identical images for two successive lines on a screen of the liquid crystal panel, and wherein each of the source line driving circuits includes an image data holding circuit to hold the interlaced image data, a mask data holding circuit to hold the mask data, and an image data masking circuit to provide the replacement data and the image data read out from the image data holding circuit selectively, in accordance with data obtained from the mask data holding circuit so as to generate a driving signal to provide to corresponding one of the source lines.

### BRIEF DESCRIPTION OF THE DRAWINGS

FIG. 1 is a block diagram showing a source line driver serving as a liquid crystal display driver according to a first embodiment of the present invention.

FIG. 2 is a block diagram showing an example of a source line driving circuit configuring the source line driver of FIG. 1.

FIGS. 3A to 3D illustrate circuit diagrams showing examples of a masking circuit constituting the source line driving circuit of FIG. 2.

FIG. 4 is a waveform chart showing an operation of the source line driver of FIG. 1.

FIG. 5 is a waveform chart showing an operation of the source line driver of FIG. 1 to display a one-line horizontal line.

FIGS. 6A and 6B show combinations of black and white data superposed on image data.

FIGS. 7A and 7B show an example of encoded mask data.

FIG. 8 is a block diagram showing a source line driver serving as a liquid crystal display driver according to a second embodiment of the present invention.

FIG. 9 is a block diagram showing a example of a source line driving circuit constituting the source line driver of FIG. 8.

FIG. 10 is a block diagram showing the configuration of a liquid crystal display device equipped with the source line driver according to the first embodiment.

FIG. 11 is a block diagram showing the configuration of a liquid crystal display device equipped with the source line driver according to the second embodiment.

FIGS. 12A to 12C show examples to display halftone.

### DETAILED DESCRIPTION OF THE INVENTION

Embodiments of the present invention will be described below with reference to the drawings.

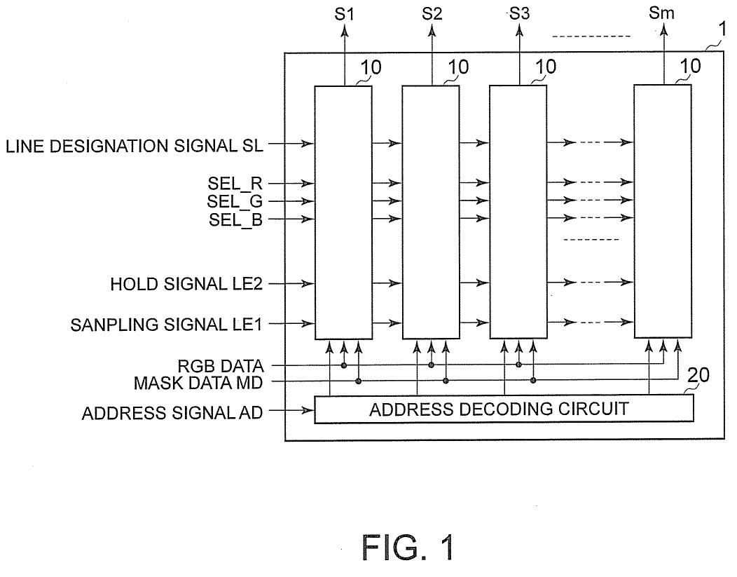

A source line driver serving as a liquid crystal display driver according to a first embodiment of the present invention will be described with reference to FIG. 1. FIG. 1 is a block diagram showing the configuration of the source line driver.

An active matrix type liquid crystal panel is provided with m×n number of liquid crystal pixels which are arranged in a lattice or matrix pattern. “m” and “n” are positive integers. TFTs are connected to the m×n number of liquid crystal pixels. The TFTs have source electrodes respectively. The source line driver of FIG. 1 drives of the source electrode of the TFTs.

In FIG. 1, the source line driver 1 is provided with m number of source line driving circuits 10, . . . , 10 respectively for driving m number of source lines S1, . . . , Sm of the liquid crystal panel.

Furthermore, the source line driver 1 is provided with an address decoding circuit 20 for generating address data in order to designate one of the source line driving circuits 10, . . . , 10 into which RGB data is captured on the basis of an address signal AD.

The designated source line driving circuit 10, as will be described below in detail, captures and holds RGB data during the period of displaying the RGB data in two lines (even- and odd-numbered lines). The source line driving circuit 10 converts the held data to an analogue voltage, and outputs the voltage to a line designated by a line designation signal SL.

At this moment, according to designation of mask data MD, the source line driving circuit 10 switches whether to output the received voltage to the line, or to output predetermined image data to the line after replacing the received voltage with a voltage corresponding to predetermined image data, i.e. mask data). Such designation by the mask data MD is performed for every one line.

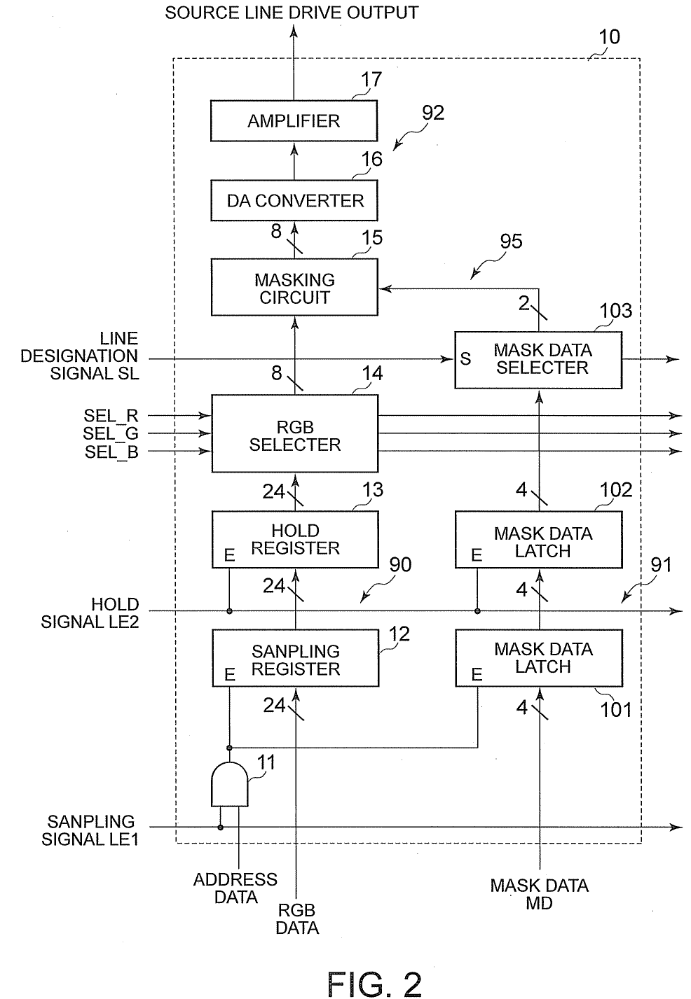

FIG. 2 shows an example of each source line driving circuit 10. The example uses RGB data including red (R), green (G) and blue (B) data, each of which is composed of 8 bits. Thus, the RGB data is composed of 24 bits in total.

Each of the source line driving circuits 10, . . . , 10 is provided with a 24-bit sampling register 12, a 24-bit hold register 13 and an RGB selector 14. The sampling register 12 captures pixel-based RGB data in response to a sampling signal LE1 outputted through an AND gate 11 when address data is inputted.

In response to a hold signal LE2 outputted for every two-line display period, the hold register 13 captures and holds the RGB data held in the sampling register 12.

The RGB selector 14 outputs 8-bit R data, 8-bit G data and 8-bit B data, which are divided from 24-bit RGB data held in the hold register 13, in a time-sharing manner in response to designation inputs of SEL_R, SEL_G and SEL_B, respectively. The designation inputs of SEL_R, SEL_G and SEL_B are used to switch R data, G data and B data corresponding to picture elements (not shown) of R, G and B, which are colors of light incident to the liquid crystal of the liquid crystal panel.

At the same time, each of the source lines S1 to Sm is switched to connect with each of the picture elements of R, G and B of the liquid crystal panel by each of analog switches (not shown). The sampling resister 12 and the hold register 13 constitute an image data holding circuit 90.

Each of the source line driving circuits 10, . . . , 10 is provided with 4-bit mask data latches 101 and 102 as well as with a mask data selector 103. The mask data latch is a mask data latch circuit. The mask data latches 101 and 102 constitute a mask data holding circuit 91.

The mask data latch 101 captures pixel-based mask data MD in response to the sampling signal LE1 outputted through the AND gate 11 when address data is inputted, as the sampling resister 12 does. In the mask data MD, each pixel is composed of four bits for two lines on a two-bit-per-line basis. The mask data MD is, as will be described below, (image) data to provide replacement data for selectively replacing the RGB data.

The mask data latch 102 captures the mask data MD held in the mask data latch 101, in response to the hold signal LE2 outputted for every two-line display period.

Upon receipt of a line designation signal SL, the mask data selector 103 outputs 2-bit mask data for each of odd- and even-numbered lines, which are divided from 4-bit mask data held in the mask data latch 102 in a time-sharing manner.

Further, each of the source line driving circuits 10, . . . , 10 is provided with a masking circuit 15, a DA converter 16 and an amplifier 17.

In response to the mask data outputted from the mask data selector 103, the masking circuit 15 switches whether to output the RGB data received from the RGB selector 14 or to output predetermined image data after replacing the RGB data with the predetermined replacement data. The masking circuit 15 is a circuit for generating a driving signal provided to one of the source lines S1 to Sm corresponding to the masking circuit 15. The mask data selector 103 and the masking circuit 15 constitute an image data masking circuit 95.

The DA converter 16 converts a digital signal outputted from the masking circuit 15 to an analogue signal. The amplifier 17 amplifies the output from the DA converter 16 and outputs the same as a source line driving output. The DA converter 16 and the amplifier 17 constitute an output circuit 92 to output the driving signal.

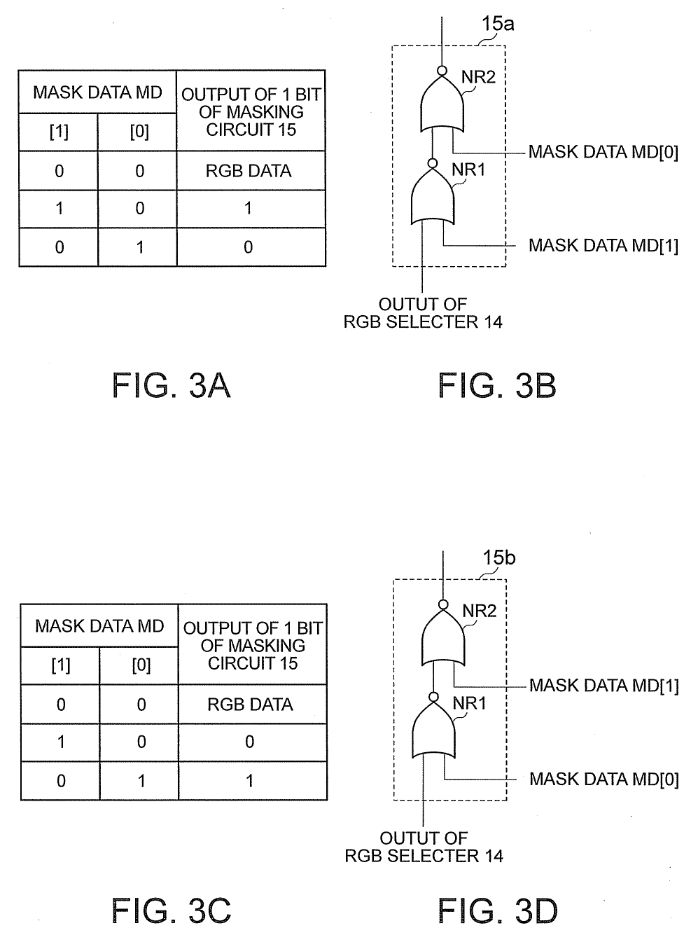

FIGS. 3A and 3C show examples of the mask data MD. FIGS. 3B and 3D show examples of a configuration for one bit of the masking circuit 15 corresponding to FIGS. 3A and 3C, respectively.

FIG. 3A shows a relationship between the combination of one bit data (mask data) MD [1] and MD [0], that constitute the 2-bit mask data MD, and the one-bit output of the masking circuit 15.

FIG. 3A shows that the one-bit output of the masking circuit 15 is the originally inputted RGB data when the mask data MD is ‘00’. The one-bit output of the masking circuit 15 is ‘1’ when the mask data MD is ‘10’. The one-bit output of the masking circuit 15 is ‘0’ when the mask data MD is ‘01’.

FIG. 3B shows a circuit 15a for one bit of the masking circuit 15 to perform such output according to the manner mentioned above. The circuit 15a is composed of NOR gates NR1 and NR2. The NOR gate NR1 receives the output from the RGB selector 14 and the mask data MD [1]. The NOR gate NR2 receives the output from the NOR gate NR1 and the mask data MD [0].

FIG. 3C shows a relationship between the combination of one bit data (mask data) MD [1] and MD [0], that constitute the 2-bit mask data MD, and the one-bit output of the masking circuit 15. As shown in FIG. 3C, when the mask data MD is ‘00’, the originally inputted RGB data is outputted. When the mask data MD is ‘10’, ‘0’ is outputted. When the mask data MD is ‘01’, ‘1’ is outputted.

FIG. 3D shows a circuit 15b for one bit of the masking circuit 15 to perform such output according to the manner mentioned above.

The circuit 15b is constituted of the NOR gates NR1 and NR2 as similar to the circuit 15a in FIG. 3B. The NOR gate NR1 receives the output from the RGB selector 14 and the mask data MD [0]. The NOR gate NR2 receives the output from the NOR gate NR1 and the mask data MD [1].

In addition to the circuits 15a and 15b shown in FIGS. 3B and 3D, it is possible to use a circuit that outputs the originally inputted RGB data when the mask data MD is ‘00’, and outputs ‘1’ when the mask data MD is ‘10’ or ‘01’. Alternatively, it is possible to use a circuit that outputs the originally inputted RGB data when the mask data MD is ‘00’, and outputs ‘0’ when the mask data MD is ‘10’ or ‘01’. Thus, the data outputted from the masking circuit 15 when the mask data MD is ‘10’ and the data outputted from the masking circuit 15 when the mask data MD is ‘01’ can be designated as a replacement data.

A case, where the replacement data is ‘FFh’ (h indicates a hexadecimal notation), that is, ‘white’ data when the mask data MD is ‘10’, and where the replacement data is ‘00h’, that is, ‘black’ data when the mask data MD is ‘01’, will be described below.

In the case, the masking circuit 15 is a circuit shown in FIG. 3B for all bits.

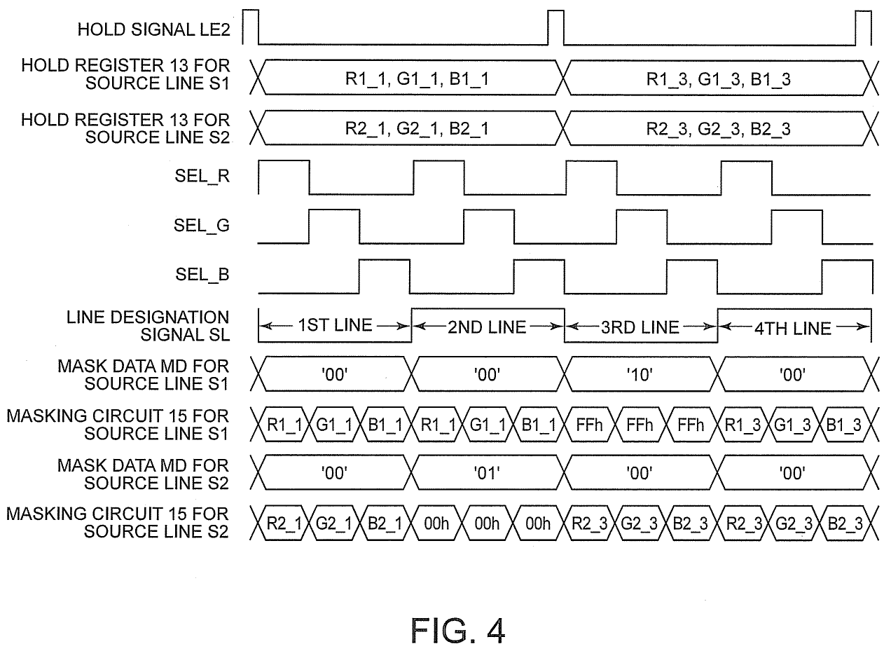

FIG. 4 is a waveform chart showing a behavior in which the output of the masking circuit 15 varies depending on the designation by the mask data MD. Now, two source line driving circuits 10, 10, which drive the source lines S1 and S2, are regarded as an example to make the following description.

The RGB data for two-line display is held in the hold resister 13 of each of the source line driving circuits 10, . . . , 10 in synchronization with the hold signal LE2.

Specifically, the RGB data (R1_1, G1_1, B1_1) of the first and second lines for outputting to the source line S1 and the RGB data (R2_1, G2_1, B2_1) of the first and second lines for outputting to the source line S2, for example, are held in the hold register 13 for the source line S1 and in the hold register 13 for the source line S2, respectively, in synchronization with the first hold signal LE2.

The RGB data (R1_3, G1_3, B1_{—3}) of the third and fourth lines for outputting to the source line S1 and the RGB data (R2_3, G2_3, B2_3) of the third and fourth lines for outputting to the source line S2 are held in the hold register 13 for the source line S1 and in the hold register 13 for the source line S2, respectively, in synchronization with the following hold signal LE2.

The data held in the hold registers 13 is divided into R data, G data and B data by the RGB selector 14 of each of the source line driving circuits 10, . . . , 10 in accordance with the designation inputs of SEL_R, SEL_G, and SEL_B

The R data, G data and B data outputted from the RGB selector 14 are transferred to the masking circuit 15. The R data, G data and B data inputted to the masking circuit 15 are output-processed by the mask data MD outputted from the mask data selector 103.

According to the line designation signal SL, the mask data selector 103 switches whether to output the mask data for the odd-numbered line or to output the mask data for the even-numbered line.

If the mask data MD for output to the source line S1 is ‘00’ in both the first and second lines, R1_1, G1_1, and B1_1 are outputted from the masking circuit 15 for output to the source line S1 in both the first and second lines.

On the other hand, if the mask data MD for output to the source line S2 is ‘00’ in the first line and ‘01’ in the second line, R2_1, G2_1 and B2_1 are outputted from the masking circuit 15 for output to the source line S2 in the first line, while ‘00h’, ‘00h’ and ‘00h’ are outputted from the masking circuit 15 for output to the source line S2 in the second line. In other words, black data is outputted to the second line.

If the mask data MD for output to the S1 is ‘10’ in the third line, ‘FFh’, ‘FFh’ and ‘FFh’, that is, white data, are outputted from the masking circuit 15 for output to the S1.

In the above manner, it is controlled as designated by the mask data MD whether to output original RGB date, white data, or black data, to every pixel of any source line of any line. The mask data MD is data to provide replacement data.

Accordingly, if mask data MD ‘10’ or ‘01’ is continuously inputted for a particular line, ‘FFh’ or ‘00h’ is outputted to the particular line from the masking circuits 15, . . . ,15 of the successive source line driving circuits 10, . . . , 10 As a result, a white or black horizontal line having a one-line width and a length corresponding to a period during which the mask data MD continues to be ‘10’ or ‘01’ is drawn in the particular line.

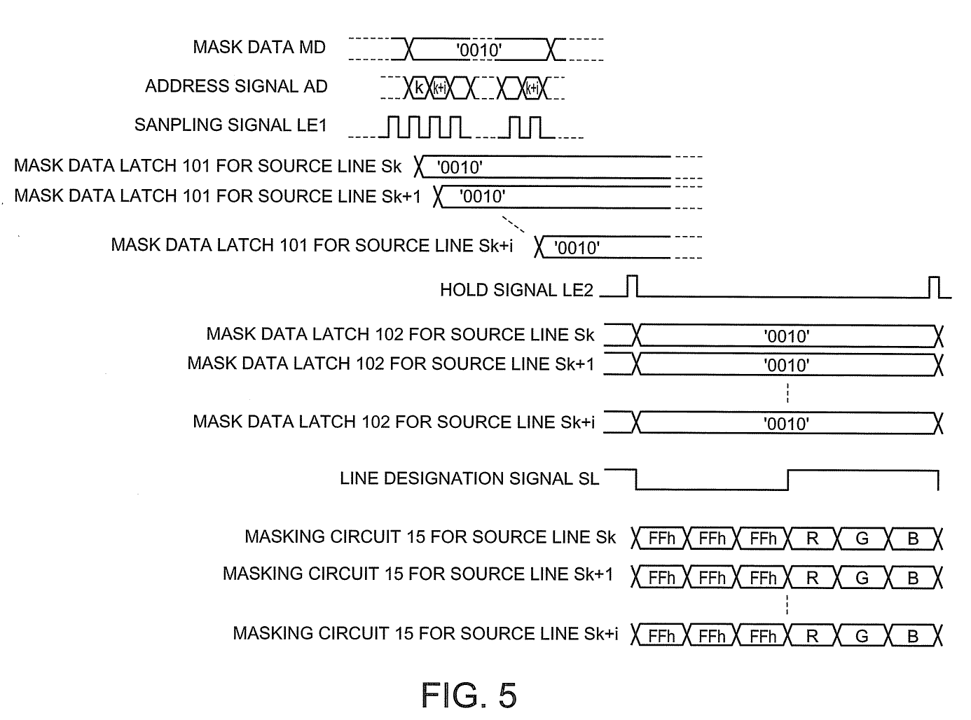

FIG. 5 shows the operation of the source line driver 1 of FIG. 1 when ‘0010’ is continuously inputted as 4-bit mask data MD. In this case, ‘10’ is inputted as 2-bit mask data MD for a first line of two lines on which the same pieces of RGB data are continuously displayed.

While an address signal AD shows addresses k to k+i, ‘0010’ is inputted as mask data MD. Such an input allows ‘0010’ to be subsequently held in the mask data latches 101, . . . , 101 of the source line driving circuits 10, . . . ,10 respectively connected to source lines Sk to Sk+1, in synchronization with the sampling signal LE1.

As the hold signal LE2 is then inputted, the data held in the mask data latch 101 is transferred to the mask data latch 102. Thus, ‘0010’ is held in the mask data latch 102.

The data held in the mask data latch 102 is divided into 2-bit pieces of data by the mask data selector 103 according to the input of the line designation signal SL. Consequently, ‘10’ is outputted as the 2-bit mask data MD for the first line of two lines continuously displayed.

If ‘10’ is inputted as the mask data MD, ‘FFh’ is outputted from the masking circuit 15 of each of the source line driving circuits 10, . . . , 10 respectively connected to the source lines Sk to Sk+1.

White color is displayed on a liquid crystal pixel to which the source lines Sk to Sk+1 are connected. In other words, a white line having a one-line width is displayed between the source lines.

According to the present embodiment, a horizontal line having a one-line width can be displayed while being superposed with the display of an interlaced image data.

Moreover, either of two colors can be displayed on pixel basis. Consequently, a two-colored image having a shape other than a horizontal line can be displayed.

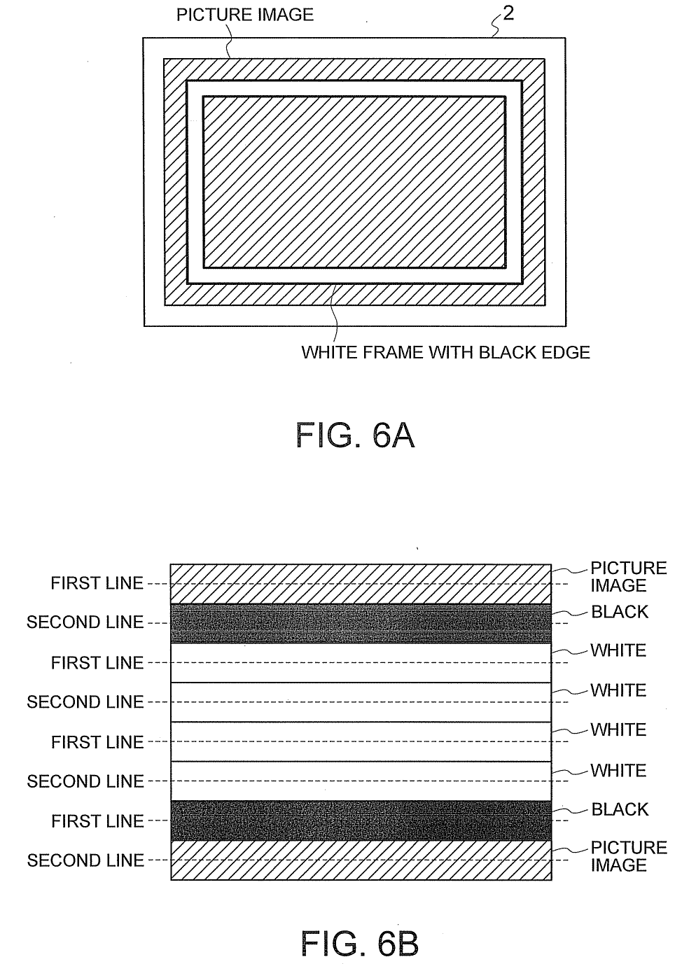

FIG. 6A shows a “white frame with black edges” as an example of such a two-colored image having any shape. FIG. 6B is an enlarged view of a part of a horizontal portion of the “white frame with black edges”.

In the “white frame with black edges”, lines adjacent to the intended image in a vertical direction of FIG. 6B are limited to lines displayed in black. A line displayed in white is never adjacent to the lines of the intended image. In other words, the number of manners in terms of the order of displaying two colors while being replaced with image data and consequently displayed so as to be seen superposed on the image data is limited.

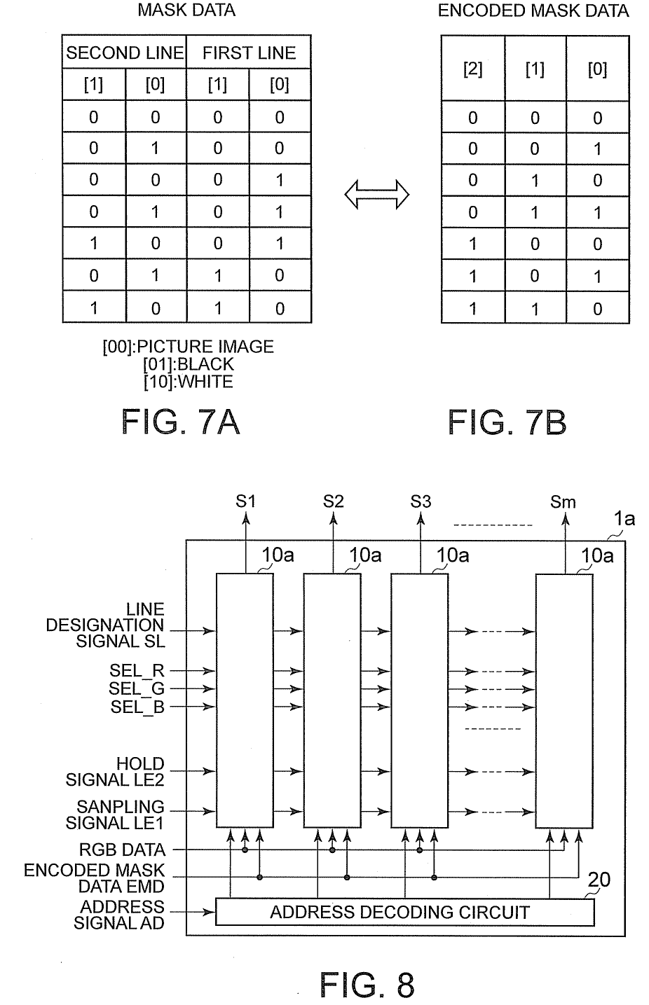

This is shown in FIG. 7A, when represented by mask data. The combinations of the data for the first and second lines are limited to seven kinds.

The 4-bit mask data shown in FIG. 7A can be encoded to display the encoded data as 3-bit encoded mask data shown in FIG. 7B.

FIG. 8 is a block diagram showing a source line driver serving as a liquid crystal display driver according to a second embodiment of the present invention, to which the encoded mask data is inputted.

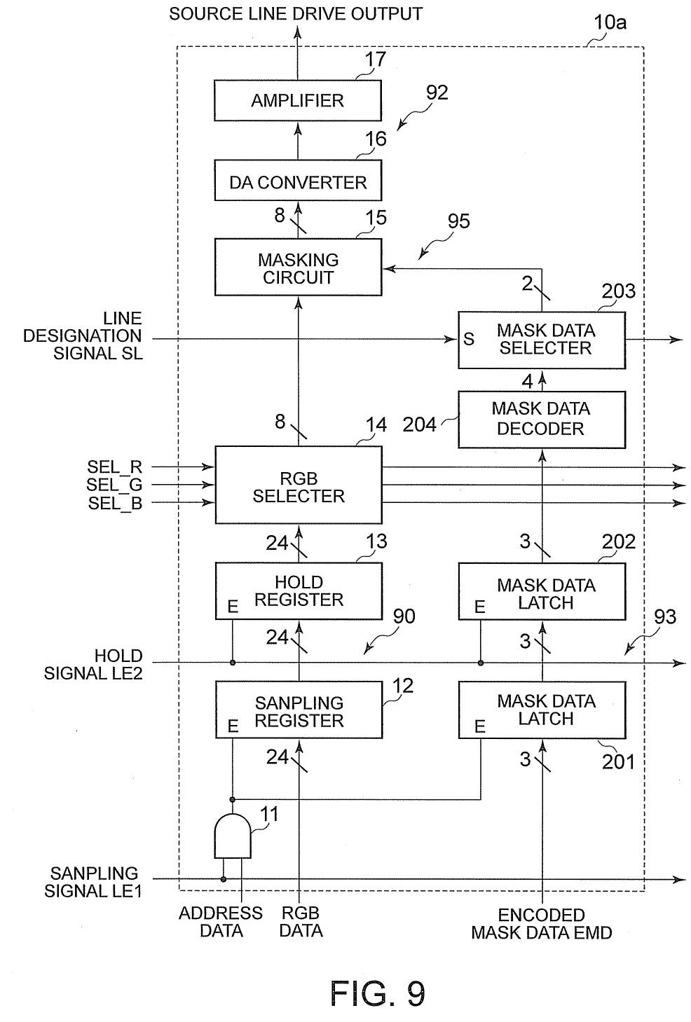

FIG. 9 is a block diagram showing an example of a source line driving circuit configuring the source line drive shown in FIG. 8.

In FIGS. 8 and 9, the same parts as those in FIGS. 1 and 2 are denoted by the same reference symbols.

As shown in FIG. 8, a source line driver 1a of the present embodiment uses source line driving circuits 10a, . . . , 10a to be described below in place of the source line driving circuits 10, . . . , 10 in FIG. 1. Encoded mask data EMD as described above is inputted to the source line driving circuits 10a, . . . , 10a.

As shown in FIG. 9, each of the source line driving circuits 10a, . . . , 10a is provided with mask data latches 201 and 202 to which the encoded mask data is inputted. The mask data latches 201 and 202 have 3-bit configuration. The mask data latches 101 and 102 of FIG. 2 have 4-bit configuration. The mask data latches 201 and 202 constitute a mask data holding circuit 93. Each of the source line driving circuit 10a, . . . , 10a is provided with a mask data decoder 204.

The mask data decoder 204 decodes the encoded mask data EMD shown in FIG. 7B to the mask data shown in FIG. 7A.

The source line driving circuit 10a of FIG. 9 can perform the same operation as that of the source line driving circuit 10 of FIG. 2.

The present embodiment allows the use of encoded mask data EMD having a small amount of data.

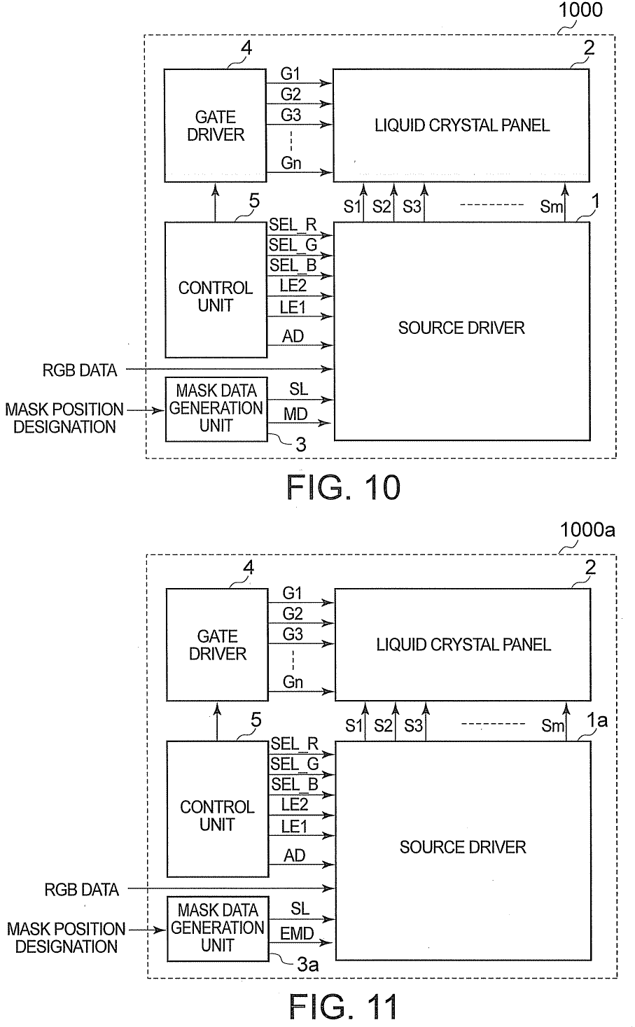

FIG. 10 is a block diagram showing an example of a liquid crystal display device equipped with the source line driver of the first embodiment shown in FIGS. 1 and 2. In FIG. 10, the same parts as those of FIGS. 1 and 2 are denoted by the same reference symbols.

In FIG. 10, a liquid crystal display device 1000 includes the source line driver 1, a liquid crystal panel 2, a mask data generation unit 3, a gate drive 4 and a control unit 5.

The liquid crystal panel 2 is driven by a signal outputted from the source driver 1 to the m number of source lines S1 to Sm. The mask data generation unit 3 generates the mask data MD and the line designation signal SL in accordance with a mask position designation input, and outputs the mask data MD and the line designation signal SL to the source line driver 1. The gate driver 4 drives n number of gate lines G1 to Gn of the liquid crystal panel 2. The control unit 5 controls the operations of the source line driver 1 and the gate driver 4.

FIG. 11 is a block diagram showing the configuration of a liquid crystal display device equipped with the source line driver according to the second embodiment. In FIG. 11, the same parts as those of FIGS. 8 to 10 are denoted by the same reference symbols.

In FIG. 11, a liquid crystal display device 1000a is provided with a mask data generation unit 3a. The mask data generation unit 3a generates the encoded mask data EMD and the line designation signal SL in accordance with a mask position designation input, and outputs the encoded mask data EMD and the line designation signal SL to the source line driver 1a.

The liquid crystal display device 1000a of FIG. 11 can draw a horizontal line having a one-line width, the horizontal line superposed with an image displayed on the liquid crystal panel 2, in accordance with the mask data EMD generated in the mask data generation unit 3a.

The liquid crystal display device 1000a can draw horizontal lines superposed with the image data in accordance with the encoded mask data EMD generated by the mask data generation unit 3a, in the horizontal lines, two colors being displayed in a limited manner in terms of the order of displaying.

The forgoing embodiments allow a white line or black line to be displayed in the case where two colors of black and white are displayed in accordance with mask data, the two colors being different from red, green and blue colors of the image data. Furthermore, a line of gray, intermediate color between black and white, can be displayed by modifying the mask data MD or the encoded mask data EMD for every frame.

When a halftone is to be displayed, the mask data generation unit 3 of FIG. 10 generates mask data MD, and the mask data generation unit 3a of FIG. 11 generates encoded mask data EMD such that an appearance ratio between white data and black data set according to a gradation level is kept constant during a display cycle consisting of a predetermined number of frames.

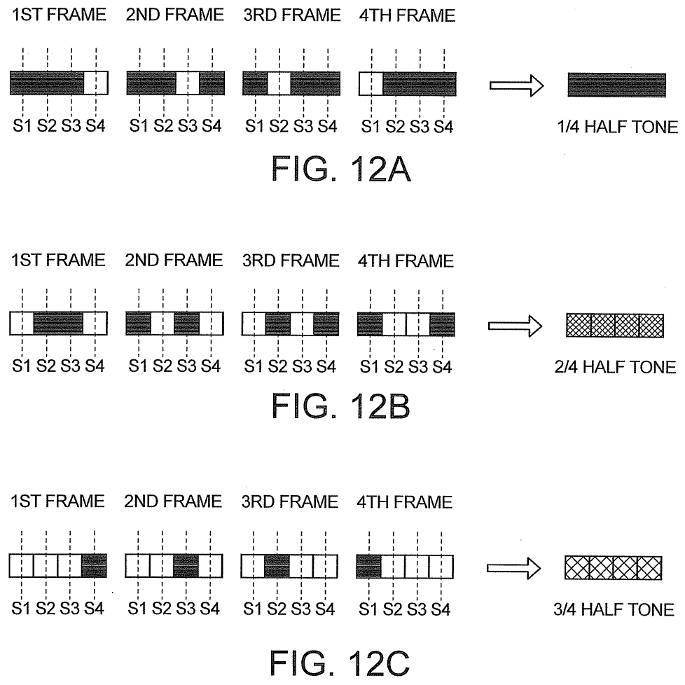

FIGS. 12A to 12C show display examples of the halftone in the case where the gradation level is set by ¼ and the same gradation level is set to be displayed in one line.

In the display examples, a single display cycle consists of four frames where white data and back data are outputted, in the respectively different orders, to the lines S1, S2, S3 and S4 of the same line.

As shown in FIG. 12A, when the appearance ratio between the white data and black data in each frame is set to 1:3, a ¼ halftone is displayed.

As shown in FIG. 12B, when the appearance ratio between the white data and black data in each frame is set to 2:2, a 2/4 halftone is displayed.

As shown in FIG. 12C, when the appearance ratio between the white data and black data in each frame is set to 3:1, a ¾ halftone is displayed.

In the above manner, halftone color expressed in gradation can also be displayed in the case where colors to be displayed by the source lines are black and white. The gradation level can be changed for every pixel. Therefore, an image having any shape other than a horizontal line with a halftone color can be displayed.

Other embodiments or modifications of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. A liquid crystal display driver, comprising source line driving circuits for driving source lines of a liquid crystal panel so as to display identical images for two successive lines on a screen of the liquid crystal panel on the basis of an interlaced image data, wherein each of the source line driving circuits includes:
an image data holding circuit to hold interlaced image data;
a mask data holding circuit to hold mask data to provide replacement data for selectively replacing the image data; and
an image data masking circuit to provide the replacement data and the image data read out from the image data holding circuit selectively, in accordance with data obtained from the mask data holding circuit, so as to generate a driving signal to provide to corresponding one of the source lines.

2. The liquid crystal display driver according to claim 1, wherein
the image data masking circuit includes a mask data selector and a masking circuit, the mask data selector outputs the mask data held in the mask data holding circuit corresponding to a line designated by a line designation signal, and the masking circuit outputs the replacement data and the image data read out from the image data holding circuit selectively on the basis of the output of the mask data selector.

3. The liquid crystal display driver according to claim 2, further comprising an output circuit including a DA converter and an amplifier, wherein
the DA converter converts a digital signal to an analogue signal, the digital signal being outputted from the image data masking circuit, and
the amplifier amplifies output of the DA converter and provide the amplified output as the driving signal to corresponding one of the source lines.

4. The liquid crystal display device according to claim 3, wherein
the image data holding circuit includes a sampling register and a hold register, the sampling register sampling the image data on the basis of a sampling signal and address data, the hold register holding the image data sampled by the sampling register, and wherein
the mask data holding circuit includes a first mask data latch and a second mask data latch, the first mask data latch latching the mask data on the basis of the address data, the second mask data latch holding the mask data latched by the first mask data latch.

5. The liquid crystal display driver according to claim 1, wherein
the image data includes red color data, green color data and blue color data, and the replacement data includes two-color data.

6. The liquid crystal display driver according to claim 5 further comprising:
an RGB selector, wherein
the RGB selector outputs the red color data, the green color data and the blue color data out of the image data held in the image data holding circuit to the image data masking circuit in a time-sharing manner in response to signals for selecting the red color data, the green color data and the blue color data.

7. The liquid crystal display driver according to claim 6, wherein
the image data masking circuit includes a mask data selector and a masking circuit, the mask data selector outputting the data held in the mask data holding circuit to the masking circuit, corresponding to a line designated by a line designation signal, and the masking circuit outputting the replacement data and the image data read out from the image data holding circuit selectively on the basis of the output of the mask data selector.

8. The liquid crystal display driver according to claim 7, further comprising an output circuit including a DA converter and an amplifier, wherein
the DA converter converts a digital signal to an analogue signal, the digital signal being outputted from the image data masking circuit, and
the amplifier amplifies output of the DA converter to provide the amplified output as the driving signal to corresponding one of the source lines.

9. The liquid crystal display device according to claim 8, wherein
the image data holding circuit includes a sampling register and a hold register, the sampling register sampling the image data on the basis of a sampling signal and address data, the hold register holding the image data sampled by the sampling register, and wherein
the mask data holding circuit includes a first mask data latch and a second mask data latch, the first mask data latch latching the mask data on the basis of the address data, the second mask data latch holding the mask data latched by the first mask data latch.

10. The liquid crystal display driver according to claim 8, wherein
the masking circuit includes a first NOR gate and a second NOR gate, the first NOR gate receiving and outputting output from the RGB selector and first data of the mask data, the second NOR gate receiving output from the first NOR gate and second data of the mask data so as to output the output from the first NOR gate and the second data of the mask data to the output circuit.

11. The liquid crystal display driver according to claim 1, further comprising a mask data decoder, wherein
the mask data inputted and held in the mask data hold circuit is encoded mask data, and
the mask data decoder decodes the encoded mask data held in the mask data hold circuit to output the decoded mask data to the image data masking circuit.

12. The liquid crystal display driver according to claim 11, wherein
an image data masking circuit includes a mask data selector and a masking circuit, the mask data selector outputting the mask data outputted from the mask data decoder to the masking circuit, corresponding to a line designated by a line designation signal, the masking circuit outputting the replacement data and the image data read out from the image data holding circuit selectively on the basis of the output of the mask data selector.

13. The liquid crystal display driver according to claim 12, further comprising an output circuit including a DA converter and an amplifier, wherein
the DA converter converts a digital signal to an analogue signal, the digital signal being outputted from the image data masking circuit, and
the amplifier amplifies output of the DA converter to provide the amplified output as the driving signal to corresponding one of the source lines.

14. The liquid crystal display device according to claim 13, wherein
the image data holding circuit includes a sampling register and a hold register, the sampling register sampling the image data on the basis of a sampling signal and address data, the hold register holding the image data sampled by the sampling register, and wherein
the mask data holding circuit includes a first mask data latch and a second mask data latch, the first mask data latch latching the mask data on the basis of the address data, the second mask data latch holding the mask data latched by the first mask data latch.

15. The liquid crystal display driver according to claim 14, wherein
the image data includes red color data, green color data and blue color data, and the replacement data includes two-color data.

16. The liquid crystal display driver according to claim 14, wherein
the masking circuit includes a first NOR gate and a second NOR gate, the first NOR gate receiving and outputting output from the RGB selector and first data of the mask data, the second NOR gate receiving output from the first NOR gate and second data of the mask data so as to output the output from the first NOR gate and the second data of the mask data to the output circuit.

17. A liquid crystal display device comprising:
a liquid crystal panel;
a source driver including source line driving circuits to receive interlaced image data to drive source lines of the liquid crystal panel;
a gate driver to drive gate lines of the liquid crystal panel;
a mask data generation unit to providing the source driver with mask data for providing replacement data of the image data; and
a control unit to control the source driver and the gate driver,
wherein the image data is provided to the source line driving circuits so as to display identical images for two successive lines on a screen of the liquid crystal panel, and
wherein each of the source line driving circuits includes:
an image data holding circuit to hold the interlaced image data;
a mask data holding circuit to hold the mask data; and
an image data masking circuit to provide the replacement data and the image data read out from the image data holding circuit selectively in accordance with data obtained from the mask data holding circuit, so as to generate a driving signal to provide to corresponding one of the source lines.

18. The liquid crystal display device according to claim 17, wherein
the image data masking circuit includes a mask data selector and a masking circuit, the mask data selector outputting the mask data held in the mask data holding circuit to the masking circuit, corresponding a line designated by a line designation signal, the masking circuit outputting the replacement data and the image data read out from the image data holding means selectively on the basis of the output of the mask data selector.

19. The liquid crystal display device according to claim 18, wherein
the image data includes red color data, green color data and blue color data, and the replacement data includes two-color data.

20. The liquid crystal display device according to claim 19, wherein,
the mask data generation unit sets the mask data such that an appearance ratio between one color data and the other color data of the two color data is kept constant during a cycle including a plurality of frames, when the mask data is to be displayed in a halftone on the liquid crystal panel, the appearance ratio being set according to a gradation level.
